(19) United States
(12) Patent Application Publication
(10) Pub. No.: US 2008/0313743 A1
(43) Pub. Date: Dec. 18, 2008

(54) Network Software License Management and Piracy Protection

(76) Inventors: Brian Chan, Castro Valley, CA (US); Steve Nelson, San Jose, CA (US); Victor Ivashin, Danville, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/762,665

(22) Filed: Jun. 13, 2007

(51) Int. Cl. G06F 7/04

(52) U.S. Cl. 726/28

(57) ABSTRACT

Apparatus having corresponding methods and computer-readable media comprise an input circuit to receive, from a license management server, a check-in sequence representing a plurality of different check-in times; a processor to execute a software product comprising an application, and a client license management module to add timestamps to a check-in record at the check-in times; and an output circuit to transmit the check-in record to the license management server; wherein the license management server performs a comparison between the check-in record and at least one of the check-in sequence, and an earlier check-in record previously sent by the client license management module to the license management server; and wherein the license management server transmits a violation message to the client license management module when the comparison fails; and wherein the client license management module disables the application based on the violation message.

### BACKGROUND

The present invention relates generally to software license management. More particularly, the present invention relates to network software license management and piracy protection.

Software vendors go to great lengths to ensure the restricted usage of software products by end users. In particular, vendors wish to ensure that a released software product cannot be used by a user beyond a certain date and time (for example as defined in a license agreement), and cannot be duplicated and reused on different computer systems beyond that which is deemed to be reasonable and fair.

According to one conventional solution, the user must enter a vendor-supplied license key to install or unlock a portion of the installed software. The license key can be encrypted with information that identifies the host system and the expiration date of the license key. According to another conventional solution, the user of the software product must log in to a separate authentication server. An open connection can be kept with the authentication server; if two connections exists with the same account, then a violation has occurred. Some solutions employ both of these approaches.

However, these approaches can be difficult to implement due to certain contextual requirements of the operating environment of the software product. For example, it may not be possible to guarantee that the installed software product has access to an authentication server existing on an external network. Furthermore, due to constraints such as network bandwidth and network policy constraints, the installed software product may not be able to keep an open connection to an authentication server.

### SUMMARY

In general, in one aspect, the invention features an apparatus comprising: an input circuit to receive, from a license management server, a check-in sequence representing a plurality of different check-in times; a processor to execute a software product comprising an application, and a client license management module to add timestamps to a check-in record at the check-in times; and an output circuit to transmit the check-in record to the license management server; wherein the license management server performs a comparison between the check-in record and at least one of the check-in sequence, and an earlier check-in record previously sent by the client license management module to the license management server; and wherein the license management server transmits a violation message to the client license management module when the comparison fails; and wherein the client license management module disables the application based on the violation message.

In some embodiments, the client license management module comprises a public encryption key; wherein the check-in sequence is encrypted, when received by the input circuit, according to a private encryption key; wherein the client license management module decrypts the encrypted check-in sequence using the public encryption key; and wherein the client license management module enables the application based on the check-in sequence. In some embodiments, the input circuit receives a license string for the software product, wherein the license string is encrypted according to the private encryption key; wherein the client license management module decrypts the license string using the public encryption key; and wherein the client license management module enables the application based on the license string and the check-in sequence. In some embodiments, the license string comprises: an email address of a user of the software product; and a globally unique identifier of the license management server. In some embodiments, the client license management module encrypts the license string using a further public encryption key; wherein the output circuit transmits the license string, encrypted using the further public encryption key, to the license management server; and wherein the license management server attempts decryption of the license string using a further private encryption key, and provides the check-in sequence only when the decryption is successful.

In general, in one aspect, the invention features a computer-readable media embodying instructions executable by a computer to perform a method comprising: executing a software product comprising an application, and a client license management module to receive, from a license management server, a check-in sequence representing a plurality of different check-in times, and to add timestamps to a check-in record at the check-in times; and sending the check-in record to the license management server; wherein the license management server performs a comparison between the check-in record and at least one of the check-in sequence, and an earlier check-in record previously sent by the client license management module to the license management server; and wherein the license management server transmits a violation message to the client license management module when the comparison fails; and wherein the client license management module disables the application based on the violation message.

In some embodiments, the client license management module comprises a public encryption key; wherein the check-in sequence is encrypted, when received, according to a private encryption key; wherein the client license management module decrypts the encrypted check-in sequence using the public encryption key; and wherein the client license management module enables the application based on the check-in sequence. In some embodiments, the client license management module receives a license string for the software product, wherein the license string is encrypted according to the private encryption key; wherein the client license management module decrypts the license string using the public encryption key; and wherein the client license management module enables the application based on the license string and the check-in sequence. In some embodiments, the license string comprises: an email address of a user of the software product; and a globally unique identifier of the license management server. In some embodiments, the client license management module encrypts the license string using a further public encryption key; wherein the client license management module causes transmission of the license string, encrypted using the further public encryption key, to the license management server; and wherein the license management server attempts decryption of the license string using a further private encryption key, and provides the check-in sequence only when the decryption is successful.

In general, in one aspect, the invention features a first apparatus comprising: an output circuit to transmit a check-in sequence to a second apparatus executing a software product comprising an application and a client license management module, wherein the check-in sequence represents a plurality of different check-in times, and wherein the client license management module subsequently adds timestamps to a check-in record at the check-in times; an input circuit to receive, from the client license management module, the check-in record; and a processor to perform a comparison between the check-in record and at least one of the check-in sequence, and an earlier check-in record previously received from the client license management module; wherein the output circuit transmits a violation message to the client license management module when the comparison fails; and wherein the client license management module disables the application based on the violation message.

In some embodiments, the processor encrypts the check-in sequence using a private encryption key; wherein the client license management module decrypts the check-in sequence using the public encryption key, and enables the application based on the check-in sequence. In some embodiments, the processor generates a license string for the software product, and encrypts the license string is using the private encryption key; wherein the client license management module decrypts the license string using the public encryption key, and enables the application based on the license string and the check-in sequence. In some embodiments, the license string comprises: an email address of a user of the software product; and a globally unique identifier of the first apparatus. In some embodiments, the client license management module encrypts the license string using a further public encryption key; wherein the input circuit receives the license string; and wherein the processor attempts decryption of the license string using a further private encryption key, and provides the check-in sequence only when the decryption is successful.

In general, in one aspect, the invention features computer-readable media embodying instructions executable by a first computer to perform a method comprising: sending check-in sequence to a second computer executing a software product comprising an application and a client license management module, wherein the check-in sequence represents a plurality of different check-in times, and wherein the client license management module subsequently adds timestamps to a check-in record at the check-in times; receiving, from the client license management module, the check-in record; and performing a comparison between the check-in record and at least one of the check-in sequence, and an earlier check-in record previously received from the client license management module; sending a violation message to the client license management module when the comparison fails; and wherein the client license management module disables the application based on the violation message.

In some embodiments, the method further comprises: encrypting the check-in sequence using a private encryption key; wherein the client license management module decrypts the check-in sequence using the public encryption key, and enables the application based on the check-in sequence. In some embodiments, the method further comprises: generating a license string for the software product; and encrypting the license string using the private encryption key; wherein the client license management module decrypts the license string using the public encryption key, and enables the application based on the license string and the check-in sequence. In some embodiments, the license string comprises: an email address of a user of the software product; and a globally unique identifier of the first apparatus. In some embodiments, the client license management module encrypts the license string using a further public encryption key; and wherein the method further comprises receiving the license string; attempting decryption of the license string using a further private encryption key; and providing the check-in sequence only when the decryption is successful.

The details of one or more implementations are set forth in the accompanying drawings and the description below. Other features will be apparent from the description and drawings, and from the claims.

### DESCRIPTION OF DRAWINGS

FIG. 1 shows the relationship between a License Management Server (LMS) and a software product comprising an application and a Client License Management Module (CLMM) according to some embodiments of the present invention.

FIG. 2 shows a license management system according to some embodiments of the present invention.

FIG. 3 shows detail of an LMS according to some embodiments of the present invention.

FIG. 4 shows a sample product configuration state for an LMS according to some embodiments of the present invention.

FIG. 5 shows a registration process for the license management system of FIG. 2 according to some embodiments of the present invention.

FIG. 6 shows a check-in sequence request process for the license management system of FIG. 2 according to some embodiments of the present invention.

FIG. 7 shows a check-in process for the license management system of FIG. 2 according to some embodiments of the present invention.

The leading digit(s) of each reference numeral used in this specification indicates the number of the drawing in which the reference numeral first appears.

### DETAILED DESCRIPTION

As used herein, the terms “client” and “server” generally refer to an electronic device or mechanism, and the term “message” generally refers to an electronic signal representing a digital message. As used herein, the term “mechanism” refers to hardware, software, or any combination thereof. These terms are used to simplify the description that follows. The clients, servers, and mechanisms described herein can be implemented on any standard general-purpose computer, or can be implemented as specialized devices.

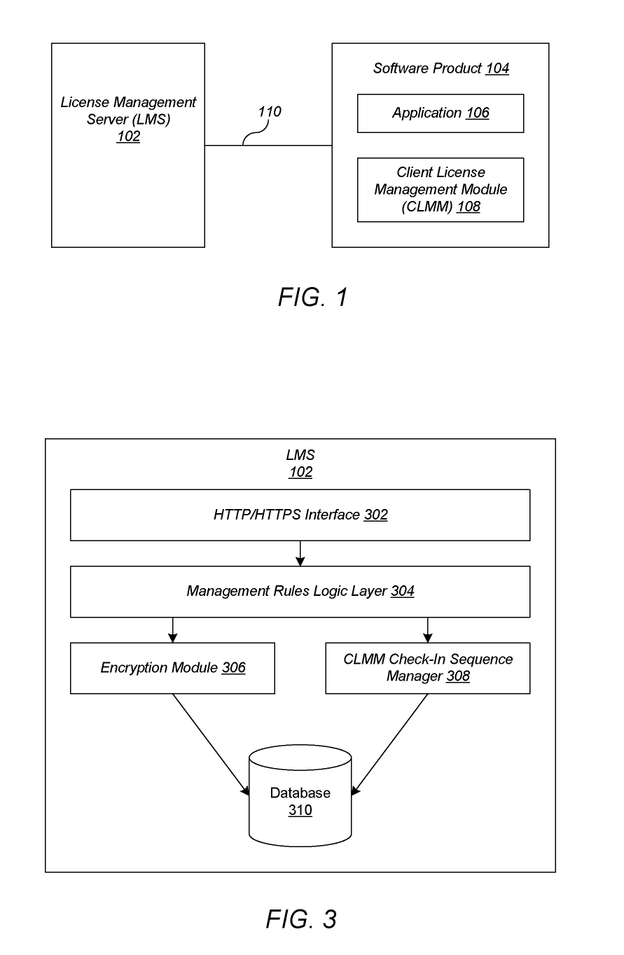

Embodiments of the present invention provide network software license management and piracy protection. In various embodiments, when a software application is installed on a client computer, a Client License Management Module (CLMM) is also installed, which communicates with a License Management Server (LMS). FIG. 1 shows the relationship between an LMS 102 and a software product 104 comprising an application 106 and a CLMM 108 according to some embodiments of the present invention. LMS 102 and CLMM 108 can communicate over a connection 110 such as http, https, and the like. CLMM 108 is sufficiently embedded into software product 104 such that it would be non-trivial to extract CLMM 108 from the software product 104, and reverse engineer CLMM 108, in order to circumvent the license.

As part of the installation process, CLMM 108 registers with LMS 102, which generates a check-in sequence that includes a sequence of check-in times, and transmits the check-in sequence to CLMM 108. At each check-in time, CLMM 108 adds a time stamp to a check-in record, which is subsequently sent to LMS 102. LMS 102 compares the check-in record to the check-in sequence, and if they do not match, sends a violation message to CLMM 108, which disables application 106.

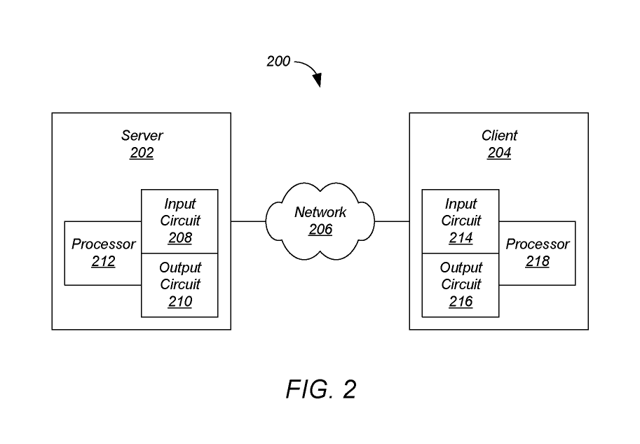

FIG. 2 shows a license management system 200 according to some embodiments of the present invention. Although in the described embodiments, the elements of license management system 200 are presented in one arrangement, other embodiments may feature other arrangements, as will be apparent to one skilled in the relevant arts based on the disclosure and teachings provided herein. For example, the elements of license management system 200 can be implemented in hardware, software, or combinations thereof.

License management system 200 includes a server 202 in communication with a client 204 over a network 206. Network 206 can be implemented as a wide-area network such as the Internet, a local-area network (LAN), or the like. While embodiments of the present invention are described with respect to network communications, they are equally applicable to devices employing other forms of data communications such as direct links and the like.

Server 202 includes an input circuit 208, and an output circuit 210, in communication with network 206. For example, input circuit 208 and output circuit 210 can be implemented as one or more conventional network interfaces. Server 202 also includes a processor 212 to execute LMS 102 of FIG. 1.

Client 204 includes an input circuit 214, and an output circuit 216, in communication with network 206. For example, input circuit 214 and output circuit 216 can be implemented as one or more conventional network interfaces. Client 204 also includes a processor 218 to execute software product 104, including application 106 and CLMM 108.

FIG. 3 shows detail of LMS 102 according to some embodiments of the present invention. LMS 102 can act as an authentication server for software product 104 by generating, managing, and monitoring license keys. LMS 102 includes an HTTP/HTTPS interface 302, a management rules logic layer 304, an encryption module 306, a CLMM check-in sequence manager 308, and a database 310.

HTTP/HTTPS interface 302 serves as a front end for providing management of LMS 102 by designated license management (LM) administrators. HTTP/HTTPS interface 302 is also the interface through which CLMM 108 interacts with LMS 102. LMS 102 can be managed by one or more administrators. The roles of an LM administrator are now described.

The LM administrator is responsible for creating end-user accounts. Usually the end user requests a license string from a vendor of software product 104. Once this request is approved, the LM administrator logs-in to LMS 102 and creates an account using some form of identifier for that end-user, such as an email address and the like.

At any time the LM administrator can log in to view the released licenses and the registered software installations that are associated with them. The LM administrator can also extend license expiration dates, and can view the check-in history of software product 104.

The LM administrator can add software product releases to LMS 102. Each software release has a record that contains a unique encryption key pair including a public key and a private key. This key pair is used by CLMM 108 to authenticate information delivered by LMS 102, and to counter possible spoofing of LMS 102.

Management rules logic layer 304 implements and executes the security policy described herein. Encryption module 306 includes a set of software tools to programmatically generate random security keys, and to send and receive encrypted information. The usage of these tools is defined by management rules logic layer 304.

CLMM check-in sequence manager 308 generates unique check-in sequences, as described in detail below. The use of these check-in sequences can deter two CLMMs 108 operating at the same time with the same license key, for example if the end user has copied the entire program directory of software product 104 to a different computer.

Database 310 manages and stores persistent information involved in implementing the security policy described herein. Implementation of the security policy has four major phases: product configuration, registration, check-in request, and check-in. In the product configuration phase, the LM administrator registers each release of software product 104 to LMS 102. Encryption module 306 of LMS 102 generates a new public/private key pair for each release. Each key pair is kept in permanent storage on database 310 of LMS 102. Alternatively, the LM administrator can register a new release of software product 104 by first generating a public key/private key pair using a separate utility. The LM administrator then commits this key pair into LMS 102 through interface 302.

The public key can be hard-coded into the code base of the corresponding CLMM 108 for compilation. The final software product 104 thus contains the hard-coded public key, which is used by CLMM 108 to authenticate information sent from LMS 102 during the check-in request and check-in phases.

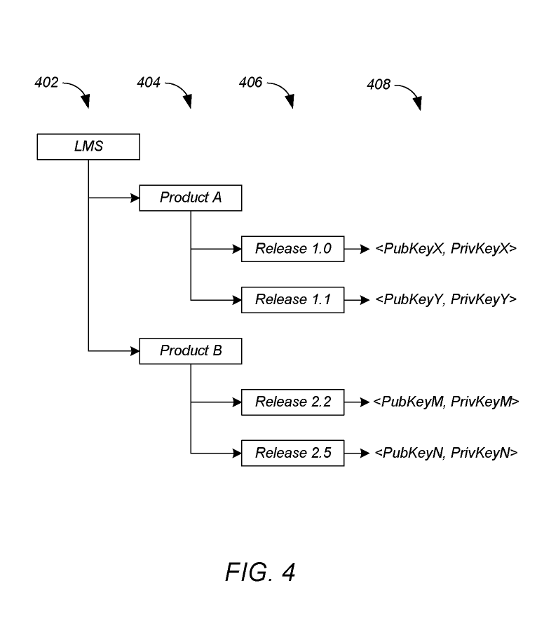

FIG. 4 shows a sample product configuration state 400 for an LMS 402 according to some embodiments of the present invention. In this example, two software products 404 have been registered on LMS 402. Each software product 404 has two different separate releases 406. Each release 406 has a corresponding product release key 408, for example such as a public/private key pair and the like. A corresponding product release key 408 is embedded within the corresponding CLMM 108.

In some embodiments, product release key 408 is implemented as a public/private key pair, as shown in FIG. 4. The product release public key is embedded within the CLMM 108. The corresponding product release private key is stored in LMS 102. This key pair is used by CLMM 108 to validate the authenticity of LMS 102 when CLMM 108 logs in to LMS 102.

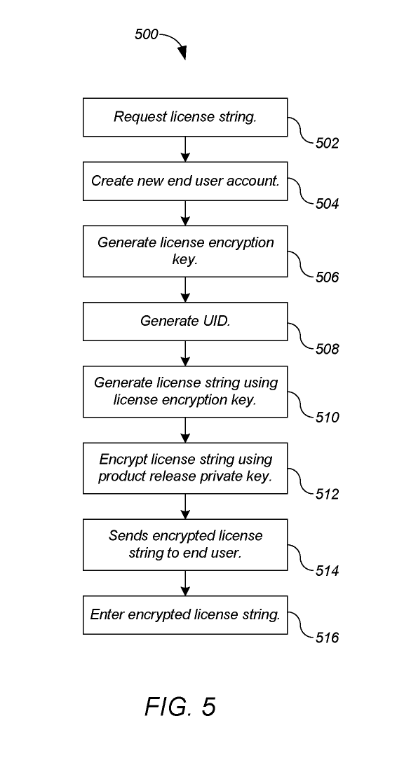

FIG. 5 shows a registration process 500 for license management system 200 of FIG. 2 according to some embodiments of the present invention. Registration process 500 begins after the end user has installed software product 104. The end user then communicates with the LM administrator to request a license string (step 502).

Upon receiving the request, the LM administrator verifies the authenticity of the end user. Any authentication method can be used. After verifying the request, the LM administrator logs in to the LMS 102 to create a new end user account (step 504), at the same time specifying any product release information.

LMS 102 generates a license encryption key (step 506), which is subsequently used to generate the license string, as described below. LMS 102 also generates a globally unique identifier string (UID—step 508). The UID is unique to LMS 102 over time. Any conventional technique can be used to generate the license encryption key and UID.

LMS 102 generates the license string using the license encryption key (step 10). In some embodiments, LMS 102 encrypts a concatenation of two strings, the email address of the end user and the UID, using the license encryption key, to produce the license string. LMS 102 then commits the registration information.

LMS 102 then encrypts the license string using the product release private key (step 512). This step ensures that only a proper CLMM 108 can decrypt the license string. LMS 102 then sends the encrypted license string to the end user (step 514).

The end user enters the encrypted license string (step 516), which CLMM 108 can decrypt using the product release private key either before or after saving the license string into permanent storage. The end user also enters LMS 102 contact information (such as IP address or URL), so that CLMM 108 can communicate with LMS 102.

Having an encrypted license string, CLMM 108 determines whether access should be granted to the end user for the use of software product 104. CLMM 108 is embedded within the code base of software product 104 in such a way that at least some significant portion of application 106 cannot function without CLMM 108 granting access. Any technique can be used to embed CLMM 108.

According to embodiments of the present invention, CLMM 108 must receive a check-in sequence from LMS 102 before enabling application 106. The check-in sequence is a sequence of time values, which can be random, generated by LMS 102. Upon receiving the check-in sequence, CLMM 108 enables application 106 (that is, grants access for the use of some or all of application 106).

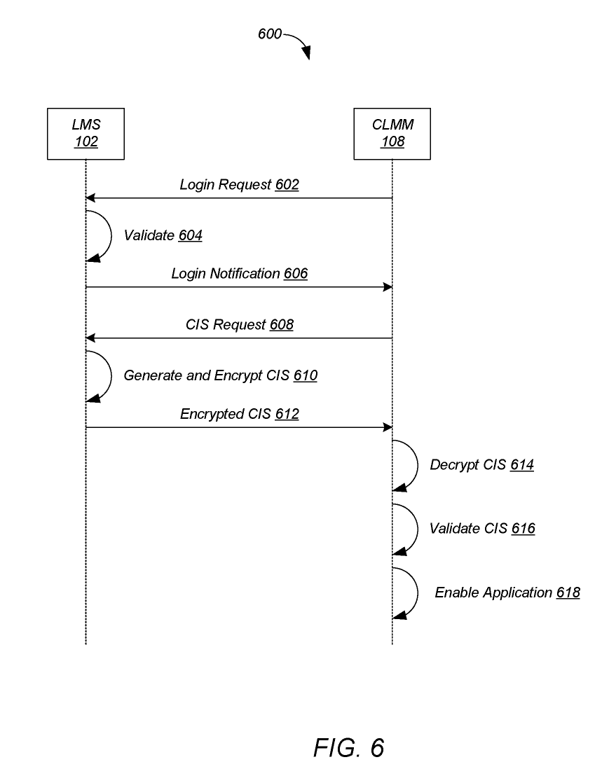

FIG. 6 shows a check-in sequence request process 600 for license management system 200 of FIG. 2 according to some embodiments of the present invention. In some embodiments, CLMM 108 initiates a check-in sequence request, although in other embodiments, the check-in sequence request can be initiated by LMS 102. CLMM 108 sends a login request to LMS 102 (step 602). In some embodiments, the login request includes the email address that was registered with software product 104 and the license string (decrypted using the product release public key). In some embodiments, CLMM 108 encrypts the login request before transmission, for example using the public key of LMS 102.

LMS 102 receives the login request, and if necessary, decrypts the login request, for example using the private key of LMS 102. If the login succeeds (step 604), LMS 102 creates a new session for CLMM 108, and sends a login notification to CLMM 108 (step 606).

After receiving a successful login notification, CLMM 108 sends a check-in sequence request (step 608). LMS 102 receives this request, and checks the expiration date of the registered software product 104. If software product 104 has not expired, LMS 102 generates a new check-in sequence (step 610), as described below. LMS 102 encrypts the check-in sequence using the product release private key, and sends the encrypted check-in sequence to CLMM 108 (step 612).

CLMM 108 receives and decrypts the check-in sequence (step 614). After validating the check-in sequence (step 616), CLMM 108 sends an acknowledgement to LMS 102. The check-in sequence is then committed to permanent storage in LMS 102. LMS 102 uses the check-in sequence at a later stage to validate subsequent CLMM 108 check-ins, as described below. Having received a valid check-in sequence, CLMM 108 enables application 106 (step 618).

In some embodiments, the received check-in sequence is not saved in permanent storage by CLMM 108. Instead, each time software product 104 restarts, CLMM 108 requests a new check-in sequence from LMS 102. In other embodiments, a check-in sequence can be used over multiple uses of software product 104.

The check-in sequence is a set of time values generated by LMS 102. During the operation of software product, CLMM 108 must check in with LMS 102 according to the check-in sequence. An example check-in sequence could include the following check-in times: 19:00:53-09-23-2006, 19:32:10-09-23-2006, 19:38:45-09-24-2006, 20:01:08-09-30-2006, 21:38:33-09-30-2006. In other embodiments, the check-in sequence can specify intervals between check-in times relative to a start time, a function to generate the check-in times, or any other representation of the check-in times.

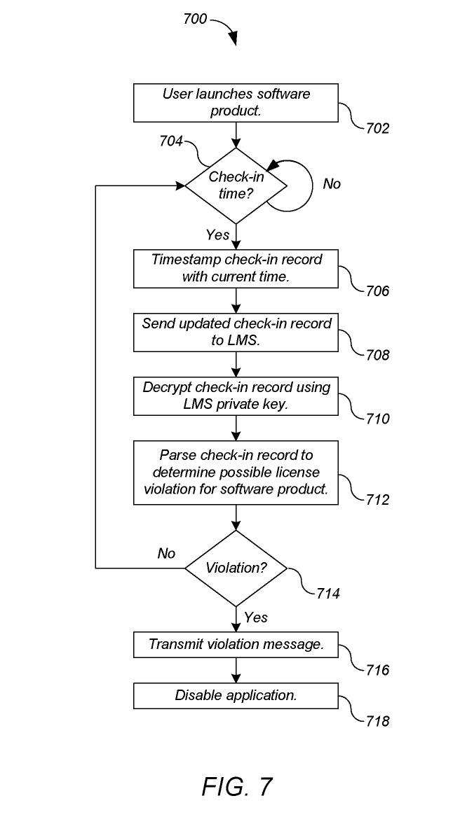

FIG. 7 shows a check-in process 700 for license management system 200 of FIG. 2 according to some embodiments of the present invention. First, a user launches software product 104 (step 702). While software product 104 is running, the embedded CLMM 108 follows the schedule specified by the check-in sequence. At each check-in time (step 704), CLMM 108 timestamps a check-in record with the current time (step 706). For example, a separate thread belonging to CLMM 108 is started, and activates according to the check-in sequence. For example, a check-in record for the example check-in sequence shown above could include the following timestamps: <19:00:53-09-23-2006, 19:32:10-09-23-2006, 19:38:45-09-24-2006>.

After updating the check-in record locally, CLMM 108 logs in to LMS 102, and sends the updated check-in record to LMS 102 (step 708). The login can be done as before, using the end user email address and the license string, encrypted by the public key of LMS 102. CLMM 108 can also encrypt the check-in record with public key of LMS 102 before transmission.

LMS 102 decrypts the check-in record after receipt using the private key of LMS 102 (step 710). LMS 102 then parses the check-in record to determine whether or not there has been a license violation for software product 104 (step 712). In some embodiments, two comparisons are made using the received check-in record. The first comparison is between the check-in record received from CLMM 108 and the original check-in sequence. For example, the received check-in record should match the original check-in sequence up to the current point in time.

The second comparison is between the check-in record received from CLMM 108 and one or more check-in records previously received from CLMM 108. For example, the current check-in record should not contain fewer timestamps than the previous check-in record. A failure of this example comparison indicates that software product 104 has been copied to a different machine and is running at the same time.

If no violation is found, process 700 waits for the next check-in time (returning to step 704). But if a violation is found (step 714), the violation is registered to database 310 of LMS 102, and can be made visible to the LM administrator. LMS 102 also transmits a violation message, which can be encrypted with the product release private key, to CLMM 108 (step 716). In response to the violation message, CLMM 108 disables application 106 (step 718).

Occasionally software product 104 must be restarted. Because at CLMM 108 the check-in sequence is kept in memory only, CLMM 108 must request a new check-in sequence after software product 104 is restarted. An end user could abuse this scenario by having two copies of software product 104 running on two separate computers, but at different times. To prevent such abuse, LMS 102 can randomly generate new encryption key pairs. The new key is used to encrypt the email address and UID again to form a new license string. LMS 102 encrypts the new license string using the product release private key, and sends the new encrypted license string to CLMM 108. CLMM 108 acknowledges the new encrypted license string, and commits this new license string to disk. On receiving an acknowledgement, LMS 102 commits the new license string to database 310. The next time CLMM 108 logs in, either to make a check-in sequence request, or to submit a check-in record, CLMM 108 must provide the correct new license string.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

What is claimed is:

1. An apparatus comprising:
an input circuit to receive, from a license management server, a check-in sequence representing a plurality of different check-in times;
a processor to execute a software product comprising
an application, and
a client license management module to add timestamps to a check-in record at the check-in times; and
an output circuit to transmit the check-in record to the license management server;
wherein the license management server performs a comparison between the check-in record and at least one of
the check-in sequence, and
an earlier check-in record previously sent by the client license management module to the license management server; and
wherein the license management server transmits a violation message to the client license management module when the comparison fails; and
wherein the client license management module disables the application based on the violation message.

2. The apparatus of claim 1
wherein the client license management module comprises a public encryption key;
wherein the check-in sequence is encrypted, when received by the input circuit, according to a private encryption key;
wherein the client license management module decrypts the encrypted check-in sequence using the public encryption key; and
wherein the client license management module enables the application based on the check-in sequence.

3. The apparatus of claim 2:
wherein the input circuit receives a license string for the software product, wherein the license string is encrypted according to the private encryption key;
wherein the client license management module decrypts the license string using the public encryption key; and
wherein the client license management module enables the application based on the license string and the check-in sequence.

4. The apparatus of claim 3, wherein the license string comprises:
an email address of a user of the software product; and
a globally unique identifier of the license management server.

5. The apparatus of claim 3:
wherein the client license management module encrypts the license string using a further public encryption key;
wherein the output circuit transmits the license string, encrypted using the further public encryption key, to the license management server; and
wherein the license management server attempts decryption of the license string using a further private encryption key, and provides the check-in sequence only when the decryption is successful.

6. Computer-readable media embodying instructions executable by a computer to perform a method comprising:
executing a software product comprising
an application, and
a client license management module to receive, from a license management server, a check-in sequence representing a plurality of different check-in times, and to add timestamps to a check-in record at the check-in times; and
sending the check-in record to the license management server;
wherein the license management server performs a comparison between the check-in record and at least one of
the check-in sequence, and
an earlier check-in record previously sent by the client license management module to the license management server; and
wherein the license management server transmits a violation message to the client license management module when the comparison fails; and
wherein the client license management module disables the application based on the violation message.

7. The computer-readable media of claim 6:
wherein the client license management module comprises a public encryption key;
wherein the check-in sequence is encrypted, when received, according to a private encryption key;
wherein the client license management module decrypts the encrypted check-in sequence using the public encryption key; and
wherein the client license management module enables the application based on the check-in sequence.

8. The computer-readable media of claim 7:
wherein the client license management module receives a license string for the software product, wherein the license string is encrypted according to the private encryption key;
wherein the client license management module decrypts the license string using the public encryption key; and
wherein the client license management module enables the application based on the license string and the check-in sequence.

9. The computer-readable media of claim 8, wherein the license string comprises:
an email address of a user of the software product; and
a globally unique identifier of the license management server.

10. The computer-readable media of claim 8:
wherein the client license management module encrypts the license string using a further public encryption key;
wherein the client license management module causes transmission of the license string, encrypted using the further public encryption key, to the license management server; and
wherein the license management server attempts decryption of the license string using a further private encryption key, and provides the check-in sequence only when the decryption is successful.

11. A first apparatus comprising:
an output circuit to transmit a check-in sequence to a second apparatus executing a software product comprising an application and a client license management module, wherein the check-in sequence represents a plurality of different check-in times, and wherein the client license management module subsequently adds timestamps to a check-in record at the check-in times;
an input circuit to receive, from the client license management module, the check-in record; and
a processor to perform a comparison between the check-in record and at least one of the check-in sequence, and
an earlier check-in record previously received from the client license management module;
wherein the output circuit transmits a violation message to the client license management module when the comparison fails; and
wherein the client license management module disables the application based on the violation message.

12. The first apparatus of claim 11:
wherein the processor encrypts the check-in sequence using a private encryption key;
wherein the client license management module decrypts the check-in sequence using the public encryption key, and enables the application based on the check-in sequence.

13. The first apparatus of claim 12:
wherein the processor generates a license string for the software product, and encrypts the license string is using the private encryption key;
wherein the client license management module decrypts the license string using the public encryption key, and enables the application based on the license string and the check-in sequence.

14. The first apparatus of claim 13, wherein the license string comprises:
an email address of a user of the software product; and
a globally unique identifier of the first apparatus.

15. The first apparatus of claim 13:
wherein the client license management module encrypts the license string using a further public encryption key;
wherein the input circuit receives the license string; and
wherein the processor attempts decryption of the license string using a further private encryption key, and provides the check-in sequence only when the decryption is successful.

16. Computer-readable media embodying instructions executable by a first computer to perform a method comprising:
sending check-in sequence to a second computer executing a software product comprising an application and a client license management module, wherein the check-in sequence represents a plurality of different check-in times, and wherein the client license management module subsequently adds timestamps to a check-in record at the check-in times;
receiving, from the client license management module, the check-in record; and
performing a comparison between the check-in record and at least one of the check-in sequence, and
an earlier check-in record previously received from the client license management module;
sending a violation message to the client license management module when the comparison fails; and
wherein the client license management module disables the application based on the violation message.

17. The computer-readable media of claim 16, wherein the method further comprises:
encrypting the check-in sequence using a private encryption key;
wherein the client license management module decrypts the check-in sequence using the public encryption key, and enables the application based on the check-in sequence.

18. The computer-readable media of claim 17, wherein the method further comprises:
generating a license string for the software product; and
encrypting the license string using the private encryption key;
wherein the client license management module decrypts the license string using the public encryption key, and enables the application based on the license string and the check-in sequence.

19. The computer-readable media of claim 18, wherein the license string comprises:
an email address of a user of the software product; and
a globally unique identifier of the first apparatus.

20. The computer-readable media of claim 18:
wherein the client license management module encrypts the license string using a further public encryption key; and
wherein the method further comprises
receiving the license string;
attempting decryption of the license string using a further private encryption key; and
providing the check-in sequence only when the decryption is successful.
